(19) United States
(12) Patent Application Publication
(10) Pub. No.: US 2020/0332841 A1
(43) Pub. Date: Oct. 22, 2020

(54) CLUTCH SYSTEMS FOR TRANSMISSIONS

(71) Applicant: Hamilton Sundstrand Corporation, Charlotte, NC (US)

(72) Inventors: Stephen Michael Bortoli, Roscoe, IL (US); Aaron M. Finke, Janesville, WI (US); Mark J. Franklin, Janesville, WI (US)

(21) Appl. No.: 16/388,123

(22) Filed: Apr. 18, 2019

(51) Int. Cl. F16D 13/58; F16D 13/52

(52) U.S. Cl. CPC F16D 13/58; F16D 2300/26; F16D 13/52

(57) ABSTRACT

A clutch basket of a clutch for a transmission can include a clutch housing shaped to house a clutch pack in the clutch housing, wherein the clutch housing has a housing outer diameter, a neck integral with and extending axially from the clutch housing, the neck having a neck outer diameter smaller than the housing outer diameter, at least a first gear integrally formed or mounted on the neck and extending radially outward from the neck, wherein the first gear includes a first gear outer diameter. In certain embodiments, the housing outer diameter can be different from the first gear outer diameter.

### BACKGROUND

### 1. Field

This disclosure relates to transmissions, more specifically to clutch systems for transmissions.

### 2. Description of Related Art

Many shifting transmissions contain a plurality of clutches (or clutch packs) and different gear sets in order to selectively change transmission gear ratios. These clutch packs open and close to route power through these different gear sets. Normally the clutch selectively transmits power along its axis to a second shaft, which is co-axial. That shaft power can be moved to a layshaft through different gear ratios.

Such conventional methods and systems have generally been considered satisfactory for their intended purpose. However, there is still a need in the art for improved clutch systems. The present disclosure provides a solution for this need.

### SUMMARY

A clutch basket of a clutch for a transmission can include a clutch housing shaped to house a clutch pack in the clutch housing, wherein the clutch housing has a housing outer diameter, a neck integral with and extending axially from the clutch housing, the neck having a neck outer diameter smaller than the housing outer diameter, at least a first gear integrally formed or mounted on the neck and extending radially outward from the neck, wherein the first gear includes a first gear outer diameter.

In certain embodiments, the housing outer diameter can be different from the first gear outer diameter. The first gear outer diameter can be smaller than the housing outer diameter such that the clutch housing extends radially outward past the first gear.

The clutch housing can include a second neck portion extending axially from the neck away from the clutch housing. The second neck portion can include a second neck outer diameter smaller than the neck outer diameter. The second neck portion can include a second gear integrally formed or mounted thereon and extending radially outward from the second neck portion, wherein the second gear includes a second gear outer diameter.

The second gear outer diameter can be different from the first gear outer diameter. In certain embodiments, the second gear outer diameter can be smaller than the first gear outer diameter such that the first gear extends radially outward of the second gear. The second neck portion can be formed integral with or separately attached to the neck.

A clutch for a transmission can include any embodiment of a clutch basket disclosed herein (e.g., as described above). The clutch can include a clutch pack disposed within the clutch housing between the clutch housing and an inner clutch member. The clutch pack is operatively connected to the clutch housing and the inner clutch member to engage the inner clutch member to the clutch housing when compressed. The clutch can include a clutch actuator configured to compress the clutch pack to engage the clutch housing to the inner clutch member.

A transmission can include an input shaft having a plurality of input gears and at least one clutch as disclosed herein (e.g., as described above). For example, the first gear of the clutch can be connected to an input gear of the plurality of input gears. In certain embodiments, the second gear can be connected to a second input gear of the plurality of input gears. Certain embodiments of a transmission include multiple embodiments of a clutch basket as disclosed herein.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional view of an embodiment of a clutch having an embodiment of a clutch basket in accordance with this disclosure;

FIG. 2 is a cross-sectional view of an embodiment of a clutch having an embodiment of a clutch basket in accordance with this disclosure;

FIG. 3 is a perspective view of an embodiment of a clutch in accordance with this disclosure; and

FIG. 4 is a cross-sectional view of an embodiment of a dual clutch arrangement.

### DETAILED DESCRIPTION

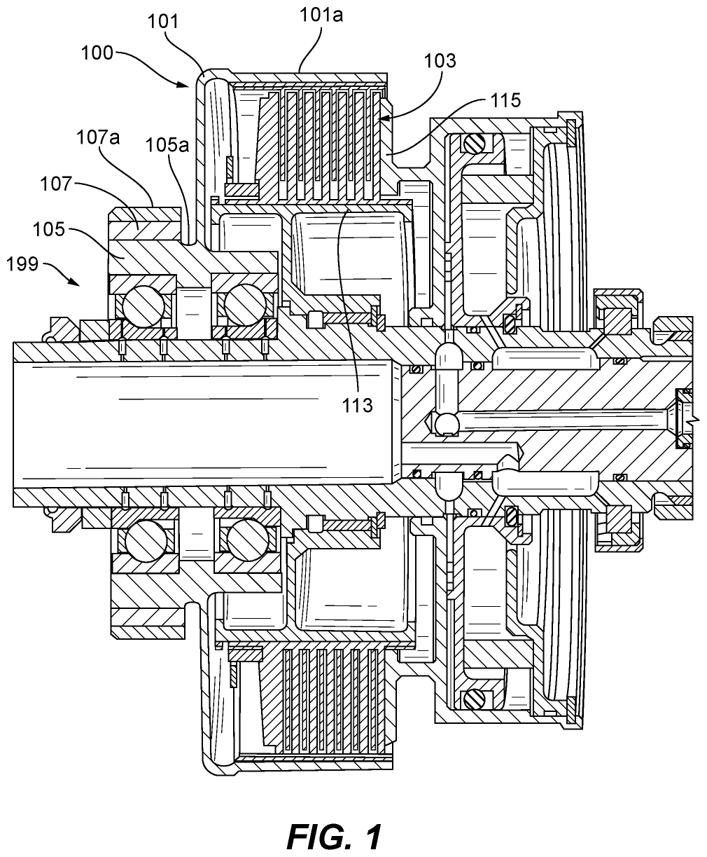

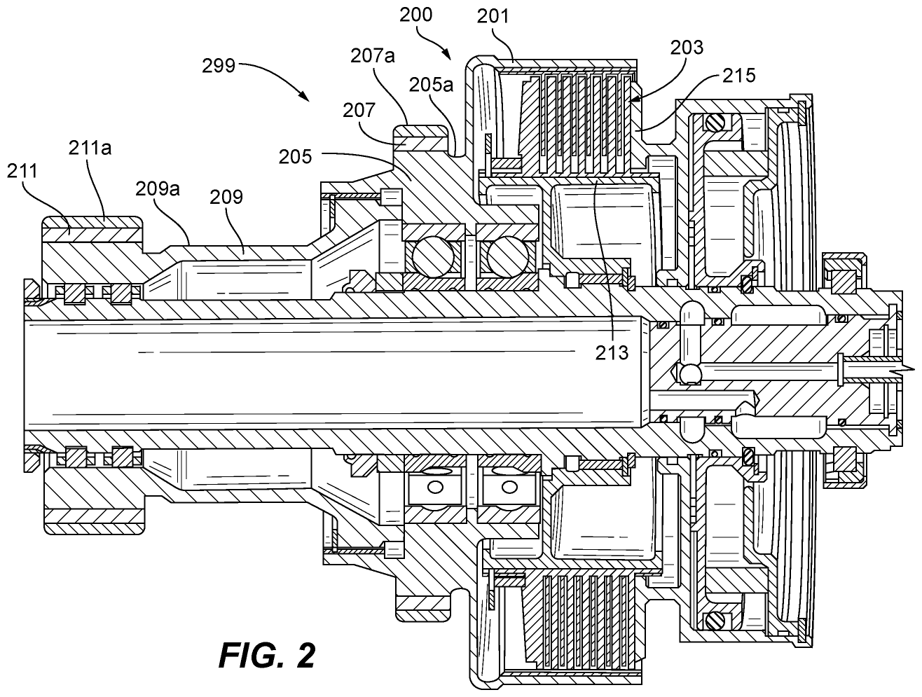

Reference will now be made to the drawings wherein like reference numerals identify similar structural features or aspects of the subject disclosure. For purposes of explanation and illustration, and not limitation, an illustrative view of an embodiment of a clutch basket in accordance with the disclosure is shown in FIG. 1 and is designated generally by reference character 100. Other embodiments and/or aspects of this disclosure are shown in FIGS. 2-4.

Referring to FIG. 1, a clutch basket 100 of a clutch 199 for a transmission (e.g., for a low spool turbomachine) can include a clutch housing 101 shaped to house a clutch pack 103 in the clutch housing 101. The clutch housing 101 has a housing outer diameter 101a.

The clutch basket 100 can include a neck 105 integral with and extending axially from the clutch housing 101. The neck 105 can include a neck outer diameter 105a smaller than the housing outer diameter 101a. Any other suitable dimension is contemplated herein.

The clutch basket 100 can include at least a first gear 107 integrally formed or mounted on the neck 105 and extending radially outward from the neck 105. The first gear 107 has a first gear outer diameter 107a.

In certain embodiments, the housing outer diameter 101a can be different from the first gear outer diameter 107a. For example, as shown, the first gear outer diameter 107a can be smaller than the housing outer diameter 101a such that the clutch housing 101 extends radially outward past the first gear 107.

Referring additionally to FIG. 2, in certain embodiments, a clutch basket 200 can also include second neck portion 209 extending axially from the neck 205 away from the clutch housing 201. The second neck portion 209 can include a second neck outer diameter 209a smaller than the neck outer diameter 205a.

The second neck portion 209 can include a second gear 211 integrally formed or mounted thereon and extending radially outward from the second neck portion 209. The second gear 211 includes a second gear outer diameter 211a.

The second gear outer diameter 211a can be different from the first gear outer diameter 207a of the first gear 207. In certain embodiments, the second gear outer diameter 211a can be smaller than the first gear outer diameter 207a such that the first gear 207 extends radially outward of the second gear 211.

The second neck portion 209 can be formed integral with or separately attached to (e.g., as shown) the neck 205. For example, the second neck portion 209 can be splined to the neck 205.

Certain embodiments of a clutch basket, e.g., 100, 200, can be made by additive manufacturing or casting, for example. Any other suitable manufacturing process is contemplated herein.

In accordance with at least one aspect of this disclosure, a clutch, e.g., 199, 299 for a transmission can include any embodiment of a clutch basket, e.g., 100, 200 disclosed herein (e.g., as described above). The clutch, e.g., 199, 299, can include a clutch pack 103, 203 disposed within the clutch housing 101, 201 between the clutch housing 101, 201 and an inner clutch member 113, 213. The clutch pack 103, 203 can be operatively connected to the clutch housing 101, 201 and the inner clutch member 113, 213 to engage the inner clutch member 113, 213 to the clutch housing 201 when compressed.

In certain embodiments, the clutch pack 103, 203 can include one or more friction plates or members connected to the inner diameter of the clutch housing 101, 201 and one or more friction plates or members connected to the inner clutch member 113, 213 configured to move relative to the one or more friction plates or members connected to the clutch housing 101, 201 to be selectively contacted therewith. Any suitable clutch pack is contemplated herein as appreciated by those having ordinary skill in the art in view of this disclosure.

The clutch, e.g., 100, 200, can include a clutch actuator 115, 215 configured to compress the clutch pack 103, 203 to engage the clutch housing 101 to the inner clutch member 213. Any suitable actuator (e.g., hydraulic as shown) is contemplated herein.

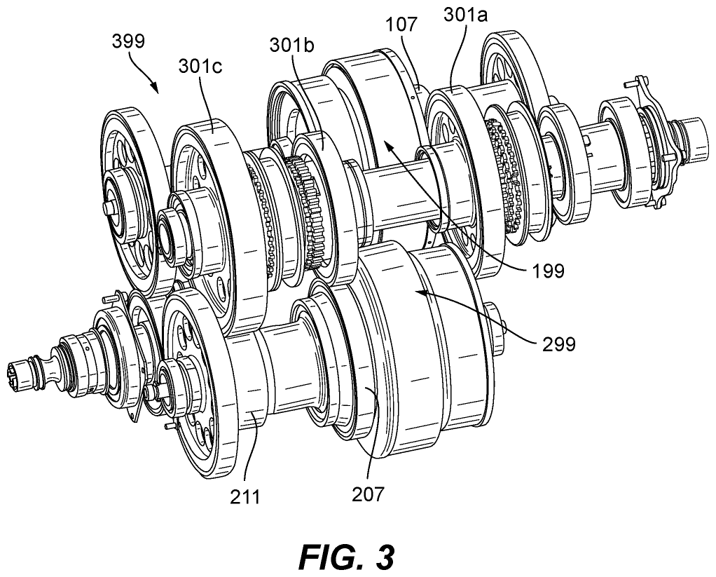

Referring additionally to FIG. 3, a transmission 399 can include an input shaft having a plurality of input gears 301a, b, c and at least one clutch, e.g., 199, 299 as shown, as disclosed herein (e.g., as described above). For example, the first gear 107, 207 of the clutch 199, 299 can be connected to an input gear 301a, 301b of the plurality of input gears. In certain embodiments, the second gear 211 can be connected to a second input gear 301c of the plurality of input gears. Certain embodiments of a transmission include multiple embodiments of a clutch and/or clutch basket as disclosed herein, e.g., as shown in FIG. 3.

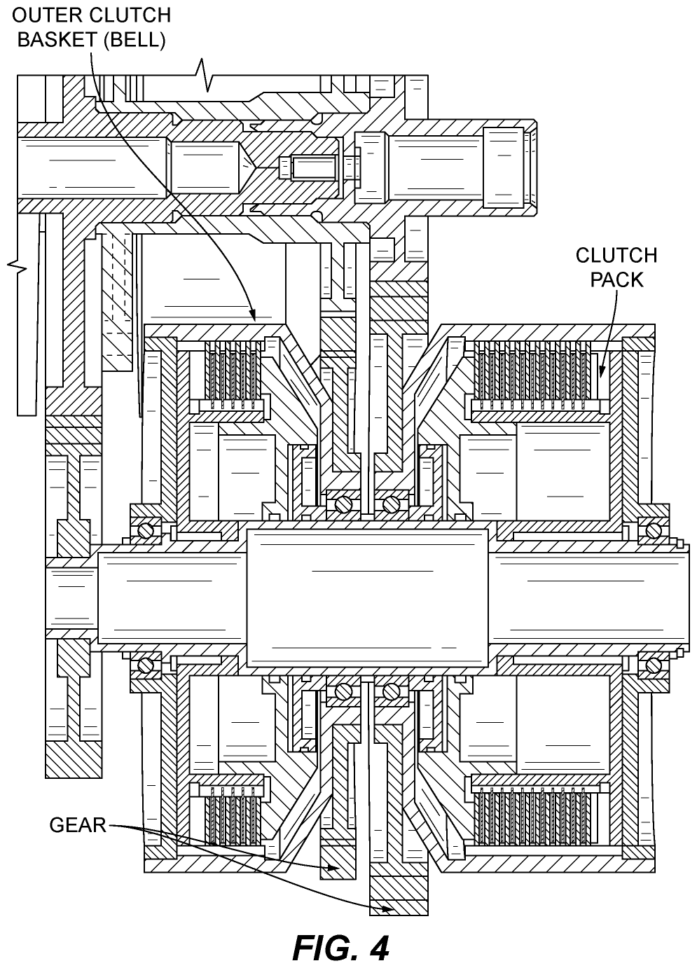

FIG. 4 shows another embodiment having a gear mounted to each clutch basket of a dual clutch. Any suitable mount type (e.g., friction fit, spline, integral formation) is contemplated herein.

Embodiments include a clutch basket (clutch bell) housing with a gear mounted and/or integral with the clutch housing. Embodiments include clutch basket mounted gears for a transmission for an aircraft low spool engine. Embodiments can be beneficial for side-by-side shaft transmission arrangements. Embodiments can reduce weight, size, and bearing count, for example, which can be especially beneficial for aircraft applications.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A clutch basket of a clutch for a transmission, comprising:
a clutch housing shaped to house a clutch pack in the clutch housing, wherein the clutch housing has a housing outer diameter;
a neck integral with and extending axially from the clutch housing, the neck having a neck outer diameter smaller than the housing outer diameter; and
at least a first gear integrally formed or mounted on the neck and extending radially outward from the neck, wherein the first gear includes a first gear outer diameter.

2. The clutch basket of claim 1, wherein the housing outer diameter is different from the first gear outer diameter.

3. The clutch basket of claim 2, wherein the first gear outer diameter is smaller than the housing outer diameter such that the clutch housing extends radially outward past the first gear.

4. The clutch basket of claim 3, further comprising a second neck portion extending axially from the neck away from the clutch housing.

5. The clutch basket of claim 4, wherein the second neck portion includes a second neck outer diameter smaller than the neck outer diameter.

6. The clutch basket of claim 5, wherein the second neck portion includes a second gear integrally formed or mounted thereon and extending radially outward from the second neck portion, wherein the second gear includes a second gear outer diameter.

7. The clutch basked of claim 6, wherein the second gear outer diameter is different from the gear outer diameter.

8. The clutch basket of claim 7, wherein the second gear outer diameter is smaller than the first gear outer diameter such that the first gear extends radially outward of the second gear.

9. The clutch basket of claim 1, wherein the second neck portion is formed integral with or separately attached to the neck.

10. A clutch for a transmission, comprising:
a clutch basket, comprising:
a clutch housing shaped to house a clutch pack in the clutch housing, wherein the clutch housing has a housing outer diameter;
a neck integral with and extending axially from the clutch housing, the neck having a neck outer diameter smaller than the housing outer diameter; and
at least a first gear integrally formed or mounted on the neck and extending radially outward from the neck, wherein the first gear includes a first gear outer diameter;
an inner clutch member disposed within the clutch basket;
the clutch pack disposed within the clutch housing between the clutch housing and an inner clutch member the clutch pack operatively connected to the clutch housing and the inner clutch member to engage the inner clutch member to the clutch housing when compressed; and
a clutch actuator configured to compress the clutch pack to engage the clutch housing to the inner clutch member.

11. The clutch of claim 10, wherein the housing outer diameter is different from the first gear outer diameter.

12. The clutch of claim 11, wherein the first gear outer diameter is smaller than the housing outer diameter such that the clutch housing extends radially outward past the first gear.

13. The clutch of claim 12, further comprising a second neck portion extending axially from the neck away from the clutch housing.

14. The clutch of claim 13, wherein the second neck portion includes a second neck outer diameter smaller than the neck outer diameter.

15. The clutch of claim 14, wherein the second neck portion includes a second gear integrally formed or mounted thereon and extending radially outward from the second neck portion, wherein the second gear includes a second gear outer diameter.

16. A transmission, comprising:
an input shaft having a plurality of input gears; and
at least one clutch having:
a clutch basket, comprising:
a clutch housing shaped to house a clutch pack in the clutch housing,
wherein the clutch housing has a housing outer diameter;
a neck integral with and extending axially from the clutch housing, the neck having a neck outer diameter smaller than the housing outer diameter; and
at least a first gear integrally formed or mounted on the neck and extending radially outward from the neck, wherein the first gear includes a first gear outer diameter, wherein the first gear is connected to an input gear of the plurality of input gears.

17. The clutch basket of claim 16, wherein the first gear outer diameter is smaller than the housing outer diameter such that the clutch housing extends radially outward past the first gear.

18. The clutch basket of claim 17, further comprising a second neck portion extending axially from the neck away from the clutch housing.

19. The clutch basket of claim 18, wherein the second neck portion includes a second neck outer diameter smaller than the neck outer diameter.

20. The clutch basket of claim 19, wherein the second neck portion includes a second gear integrally formed or mounted thereon and extending radially outward from the second neck portion, wherein the second gear includes a second gear outer diameter, wherein the second gear is connected to a second input gear of the plurality of input gears.
